(19) United States
(12) Patent Application Publication
(10) Pub. No.: US 2009/0075151 A1
(43) Pub. Date: Mar. 19, 2009

(54) FUEL CELL AND MIXING MODULE THEREOF

(75) Inventors: Shou-Chih Chen, Hsinchu (TW); Sea-Huang Lee, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CORETRONIC CORPORATION, Hsinchu (TW)

(21) Appl. No.: 12/107,878

(22) Filed: Apr. 23, 2008

(30) Foreign Application Priority Data
Sep. 13, 2007 (TW) 96134219

(51) Int. Cl. H01M 8/04; B01F 15/02; B01F 5/00

(52) U.S. Cl. 429/34; 366/182.4

(57) ABSTRACT

A fuel cell is provided comprising a cell module and a mixing module. The mixing module is connected to the cell module. A vapor current enters the mixing module from the cell module. The mixing module comprises a condensing unit, a mixing sink, and a check valve. The vapor current enters the condensing unit to be condensed into a first liquid. The mixing sink comprises a sink body and a spacer, wherein the sink body receives a second liquid, the spacer spaces the sink body and the condensing unit, the spacer comprises a through hole, and the first liquid enters the mixing sink through the through hole. The check valve is disposed in the through hole, wherein the check valve comprises a valve body and a valve cover, the valve is disposed in the through hole, and the valve cover restricts the valve body in the through hole.

### BACKGROUND OF THE INVENTION

1. Field of the Invention

The invention relates to a fuel cell, and more particularly to a fuel cell preventing solution from backflow.

2. Description of the Related Art

FIG. 1 shows a conventional fuel cell 1, which includes cell modules 10, a blower 20 and a mixing module 30. The blowers 20 are connected to the cell module 10 via flow guides 21. The cell modules 10 are connected to the mixing module 30. When the cell modules 10 are reacting, the blowers 20 blow vapor generated by the cell modules 10 toward the mixing module 30.

The mixing module 30 comprises a condensing unit and a mixing sink. The vapor enters the mixing module 30 to be condensed into water in the condensing unit. Then, the water enters the mixing sink from the condensing unit to be mixed with methanol solution in the mixing sink.

Conventionally, the condensing unit and the mixing sink are simply connected by a through hole. When the fuel cell is tilted or placed upside down, methanol solution backflows out of the fuel cell from the mixing sink. Additionally, the methanol solution is a poisonous chemical, which may corrode surrounding elements, cause fire or harm the human body.

### BRIEF SUMMARY OF THE INVENTION

A detailed description is given in the following embodiments with reference to the accompanying drawings.

A fuel cell is provided comprising a cell module and a mixing module. The mixing module is connected to the cell module. A vapor current enters the mixing module from the cell module. The mixing module comprises a condensing unit, a mixing sink, and a check valve. The vapor current enters the condensing unit to be condensed into a first liquid. The mixing sink comprises a sink body and a spacer, wherein the sink body receives a second liquid, the spacer spaces the sink body and the condensing unit, the spacer comprises a through hole, and the first liquid enters the mixing sink through the through hole. The check valve is disposed in the through hole to control movement of the first and second liquid, wherein the check valve comprises a valve body and a valve cover, the valve is disposed in the through hole, and the valve cover restricts the valve body in the through hole.

In an embodiment of the invention, a mixing module is provided, including a condensing unit, a mixing sink, and a check valve. A vapor current enters the condensing unit to be condensed into a first liquid. The mixing sink comprises a sink body and a spacer, wherein the sink body receives a second liquid, the spacer spaces the sink body and the condensing unit, the spacer comprises a through hole, and the first liquid enters the mixing sink through the through hole. The check valve is disposed in the through hole to control movement of the first and second liquid, wherein the check valve comprises a valve body and a valve cover, the valve is disposed in the through hole, and the valve cover restricts the valve body in the through hole.

In the invention, when the fuel cell is tilted or placed upside down, the methanol solution in the mixing sink is stopped by the check valve and prevented from leaking. Therefore, corrosion, fire or harm caused by methanol solution leakage is prevented, and lifespan of the fuel cell is increased.

Other objectives, features and advantages of the present invention will be understood from further technology features disclosed by the embodiments of the present invention, shown and described simply by way of illustration of modes best suited to carry out the invention.

### BRIEF DESCRIPTION OF THE DRAWINGS

The invention can be more fully understood by reading the subsequent detailed description and examples with references made to the accompanying drawings, wherein:

FIG. 1 shows a conventional fuel cell;

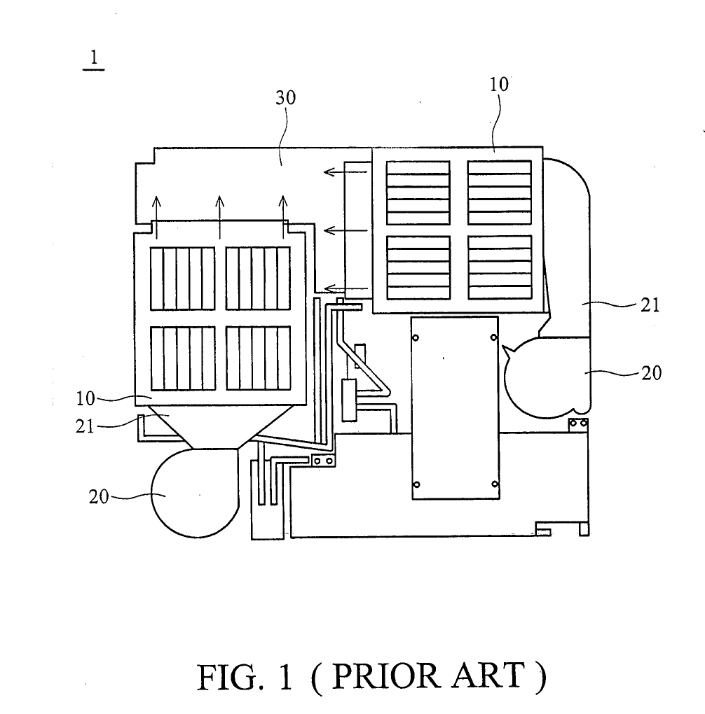

FIG. 2 shows a fuel cell of an embodiment of the invention;

FIG. 3 shows detailed structure of the mixing module;

FIG. 4a is a sectional view of the mixing module along direction I-I of FIG. 3;

FIG. 4b is an exploded view of the mixing module;

FIG. 5a is an enlarged view of portion A of FIG. 4a; and

FIG. 5b shows a check valve sealing a through hole.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

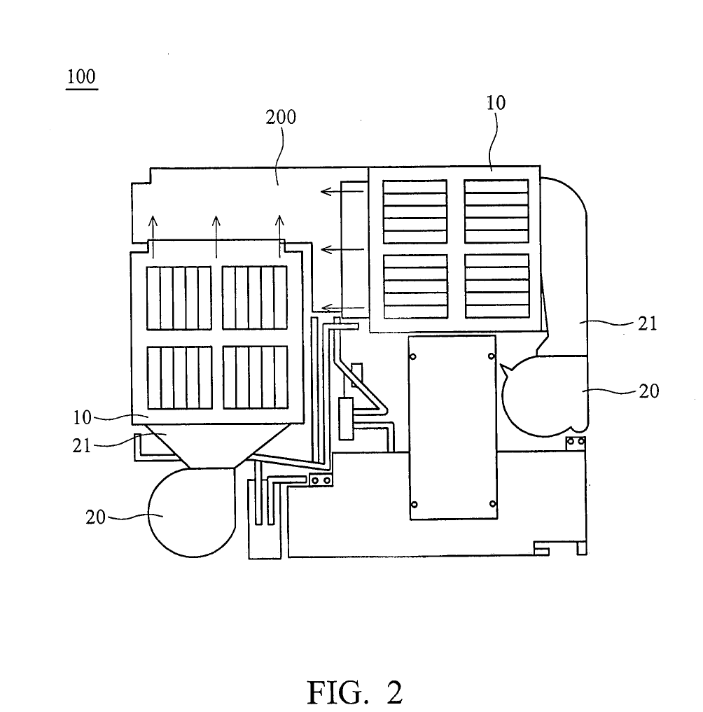

FIG. 2 shows a fuel cell 100 of an embodiment of the invention, including cell modules 10, blowers 20 and a mixing module 200. The blowers 20 are connected to the cell modules 10 via flow guides 21. The cell modules 10 are connected to the mixing module 200. When the cell modules 10 are reacting, the blowers 20 blow vapor generated by the cell modules 10 toward the mixing module 200.

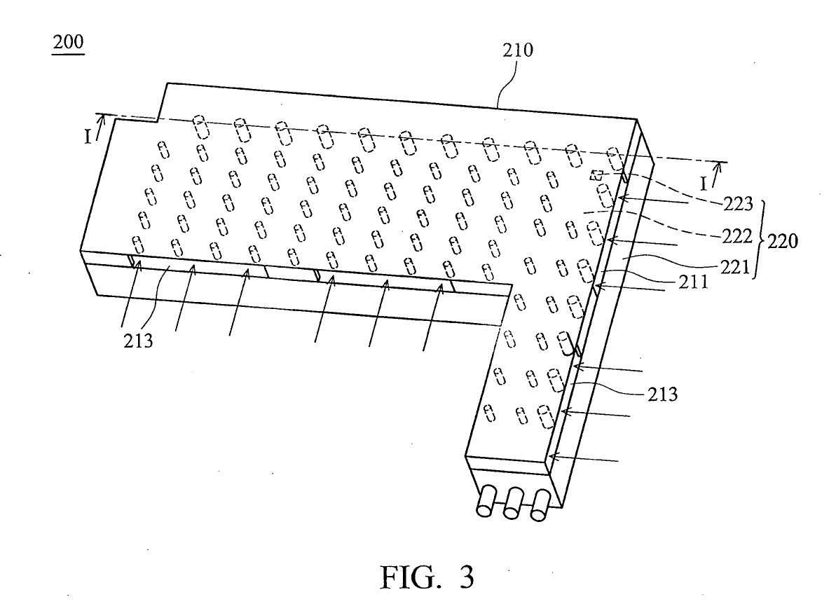

With reference to FIG. 3, the mixing module 200 includes a condensing unit 210, a mixing sink 220 and a check valve (not shows). The mixing sink 220 includes a sink body 221 and a spacer 222. The spacer 222 includes a through hole 223. The spacer 222 spaces the sink body 221 and the condensing unit 210. The through hole 223 connects the condensing unit 210 and the sink body 221. Vapor current blown by the blowers 20 enters the mixing unit 200 through inlets 213 of the condensing unit 210.

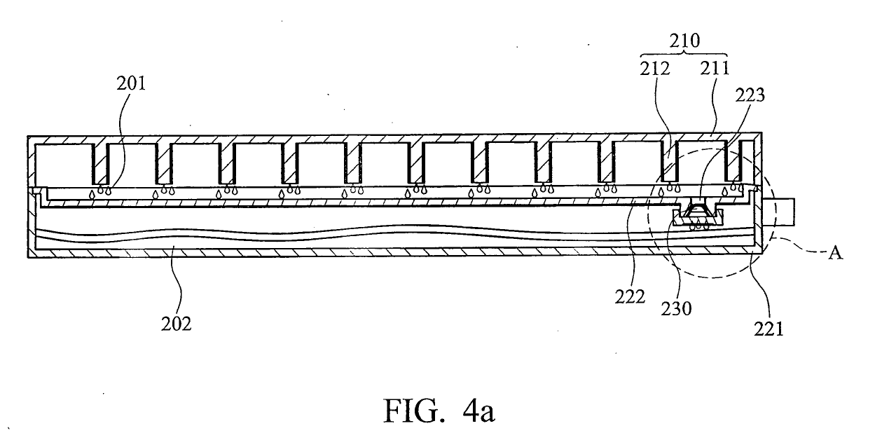

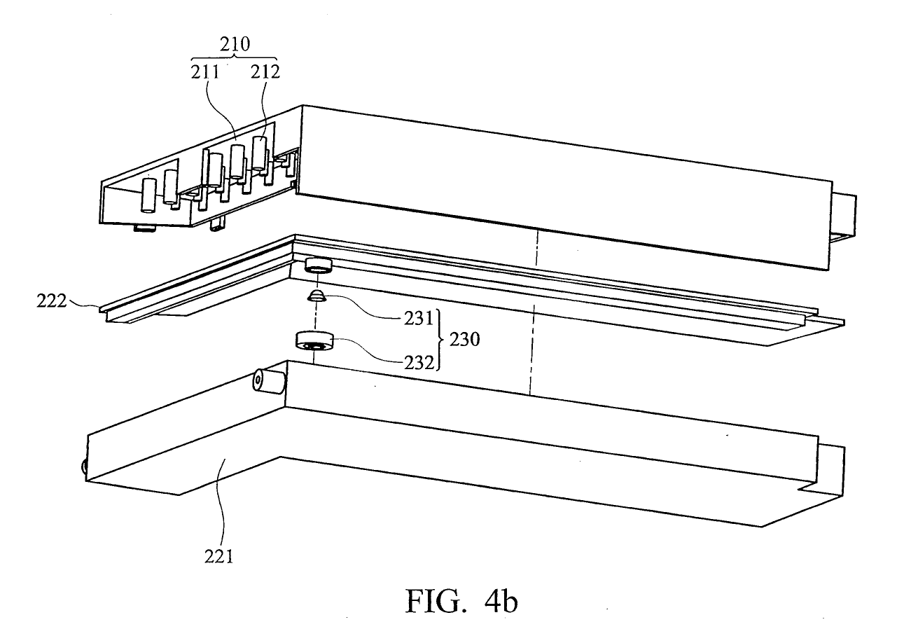

FIG. 4a is a sectional view of the mixing module 200 along direction I-I of FIG. 3, and FIG. 4b is an exploded view of the mixing module 200. With reference to FIGS. 4a and 4b, the condensing unit 210 includes a housing 211 and a plurality of condensing posts 212. The condensing posts 212 are disposed on the housing 211. When the vapor current enters the mixing module 200, the vapor current is condensed on the housing 211 and the condensing posts 212 to be water (first liquid). Next, the water travels from the condensing unit 210, passing through the through hole 223 and the check valve 230, and enters the sink body 221 to be mixed with a methanol solution (second liquid) 202 therein.

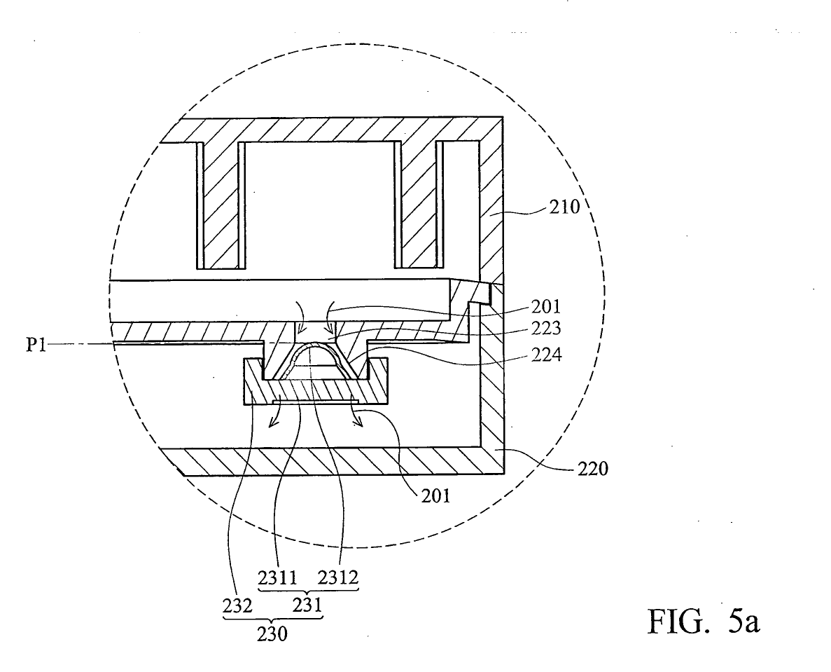

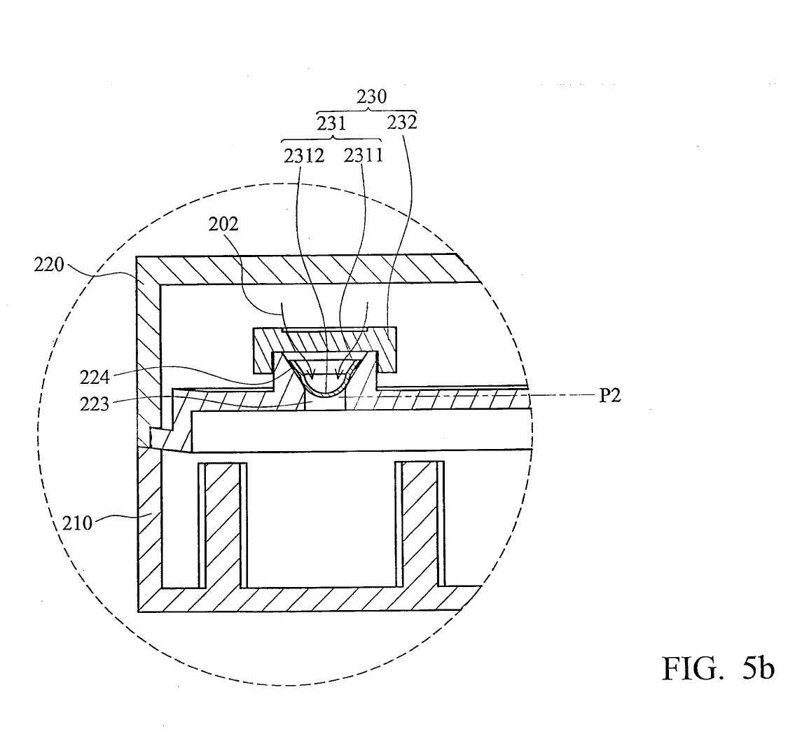

FIG. 5a is an enlarged view of portion A of FIG. 4a. With reference to FIGS. 4b and 5a, the check valve 230 includes a valve body 231 and a valve cover 232. The valve body 231 is disposed in the through hole 223. The valve cover 232 restricts the valve body 231 in the through hole 223. The through hole 223 includes a cone shaped opening 224. The valve 231 is correspondingly disposed in the opening 224.

The valve 231 is a dome element, including a top portion 2312 and a bottom portion 2311. The top portion 2312 faces the condensing unit 210. The bottom portion 2311 faces the valve cover 232. When water 201 enters the mixing sink 220 from the condensing unit 210, the valve body 231 is in a first position P1, and the bottom portion 2311 contacts to the valve cover 232 allowing the water 201 to pass through the check valve 230 to the mixing sink 220.

With reference to FIG. 5b, when the methanol solution 202 tries to enter the condensing unit 210 from the mixing sink 220, the valve body 231 is in a second position P2, and the top portion 2312 contacts to an inner wall of the opening 224 to prevent the methanol solution 202 from passing through the check valve 230.

As mentioned above, when the fuel cell is tilted or placed upside down, the methanol solution in the mixing sink is stopped by the check valve and prevented from leaking. Therefore, corrosion, fire or harm caused by methanol solution leakage is prevented, and lifespan of the fuel cell is increased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A mixing module, utilized in a fuel cell, comprising:
a condensing unit, wherein a vapor current outside the mixing module enters the condensing unit to be condensed into a first liquid;
a mixing sink, comprising a sink body and a spacer, wherein the sink body receives a second liquid, the spacer spaces the sink body and the condensing unit, the spacer comprises a through hole, and the first liquid enters the mixing sink through the through hole; and
a check valve, disposed in the through hole to control movement of the first and second liquid, wherein the check valve comprises a valve body and a valve cover, the valve is disposed in the through hole, and the valve cover restricts the valve body in the through hole.

2. The mixing module as claimed in claim 1, wherein the condensing unit comprises a housing and a plurality of condensing posts, the condensing posts are disposed on the housing, and the vapor current is condensed on the housing and the condensing posts to be the first liquid.

3. The mixing module as claimed in claim 1, wherein the through hole comprises an opening, the opening is cone shaped, and the valve body is disposed in the opening.

4. The mixing module as claimed in claim 3, wherein the valve body is a dome element.

5. The mixing module as claimed in claim 4, wherein the valve body comprises a top portion and a bottom portion, the top portion faces the condensing unit, and the bottom portion faces the valve cover.

6. The mixing module as claimed in claim 5, wherein when the first liquid enters the mixing sink from the condensing unit, and the bottom portion contacts to the valve cover allowing the first liquid to pass through the check valve.

7. The mixing module as claimed in claim 5, wherein when the second liquid tries to enter the condensing unit from the mixing sink, the top portion contacts to an inner wall of the opening to prevent the second liquid from passing through the check valve.

8. The mixing module as claimed in claim 1, wherein the valve body moves between a first position and a second position, the first liquid enters the mixing sink from the condensing unit when the valve body is in the first position, and the valve body seals the through hole to prevent the second liquid from entering the condensing unit from the mixing sink when the valve body is in the second position.

9. A fuel cell, comprising:
a cell module; and
a mixing module, connected to the cell module, a vapor current entering the mixing module from the cell module, and the mixing module comprising:
a condensing unit, wherein the vapor current enters the condensing unit to be condensed into a first liquid;
a mixing sink, comprising a sink body and a spacer, wherein the sink body receives a second liquid, the spacer spaces the sink body and the condensing unit, the spacer comprises a through hole, and the first liquid enters the mixing sink through the through hole; and
a check valve, disposed in the through hole to control movement of the first and second liquid, wherein the check valve comprises a valve body and a valve cover, the valve is disposed in the through hole, and the valve cover restricts the valve body in the through hole.

10. The fuel cell as claimed in claim 9, wherein the condensing unit comprises a housing and a plurality of condensing posts, the condensing posts are disposed on the housing, and the vapor current is condensed on the housing and the condensing posts to be the first liquid.

11. The fuel cell as claimed in claim 9, wherein the through hole comprises an opening, the opening is cone shaped, and the valve body is disposed in the opening.

12. The fuel cell as claimed in claim 11, wherein the valve body is a dome element.

13. The fuel cell as claimed in claim 12, wherein the valve body comprises a top portion and a bottom portion, the top portion faces the condensing unit, and the bottom portion faces the valve cover.

14. The fuel cell as claimed in claim 13, wherein when the first liquid enters the mixing sink from the condensing unit, the bottom portion contacts to the valve cover allowing the first liquid to pass through the check valve.

15. The fuel cell as claimed in claim 13, wherein when the second liquid tries to enter the condensing unit from the mixing sink, the top portion contacts to an inner wall of the opening to prevent the second liquid from passing through the check valve.

16. The fuel cell as claimed in claim 9, wherein the valve body moves between a first position and a second position, the first liquid enters the mixing sink from the condensing unit when the valve body is in the first position, and the valve body seals the through hole to prevent the second liquid from entering the condensing unit from the mixing sink when the valve body is in the second position.

17. The fuel cell as claimed in claim 9, further comprising a blower connected to the cell module to move the vapor current toward the mixing module.
